(19) United States
(12) Patent Application Publication
(10) Pub. No.: US 2016/0216952 A1
(43) Pub. Date: Jul. 28, 2016

(54) METHOD FOR AUTOMATICALLY FUNCTIONALLY TRANSFERRING INPUT DEVICES OF COMPUTER TO MOBILE DEVICE

(71) Applicants: Ping-Shun Zeung, Taipei City (TW); Hou-Hao Hsun, Taipei city (TW); Kun-Yuan Lin, Taipei City (TW)

(72) Inventors: Ping-Shun Zeung, Taipei City (TW); Hou-Hao Hsun, Taipei city (TW); Kun-Yuan Lin, Taipei City (TW)

(73) Assignee: I/O INTERCONNECT INC., Taipei City (TW)

(21) Appl. No.: 14/607,046

(22) Filed: Jan. 27, 2015

(51) Int. Cl. G06F 9/445; G06F 3/023; G06F 3/0354

(52) U.S. Cl. CPC G06F 8/61; G06F 3/03543; G06F 3/023

(57) ABSTRACT

The invention provides a method for directly using input devices of a personal computer to operate a mobile device connected thereto. The method includes: a) designating a specific USB port in the personal computer; b) detecting whether the mobile device is connected to the specific USB port; c) checking whether the mobile device has been installed with a first driver; d) installing the first driver to the mobile device; e) sending a command to the mobile device to make it serve as a GOOGLE accessory device; f) installing a second driver in the personal computer for the mobile device as a GOOGLE accessory device; g) transferring a control right of an input device of the personal computer to the mobile device; h) converting signals of the input device into a format compatible with the mobile device; and i) sending the converted signals to the mobile device.

### BACKGROUND OF THE INVENTION

1. Technical Field

The invention relates to combination of a personal computer and a mobile device, particularly to operable connection between input devices of a computer and a mobile device connected to the computer.

2. Related Art

Mobile devices, such as smartphones and tablets, have become an essential for most modern people. Many users of mobile devices like to connect their mobile devices to a personal computer (for example, a desktop or laptop computer) to serve as a second computer. Usually, a personal computer must be equipped with a mouse and a keyboard as input devices. Although most mobile devices are provided with a touchscreen, a mouse and keyboard are still much more convenient then a touchscreen in operation. When a user wants to use a mouse and keyboard of a personal computer to operate his or her mobile device connected to the personal computer, the user must proceed with a series of manual operations. The user cannot directly use the input devices of the personal computer to operate the mobile device without such a series of manual operations. This is not very easy for general users. However, there is no solution in the market yet.

### SUMMARY OF THE INVENTION

An object of the invention is to provide a method for automatically functionally transferring input devices of a personal computer to a mobile device, which can automatically transfer the control right of input devices of a personal computer to a mobile device connected to the personal computer without any manual operation.

To accomplish the above object, the method of the invention includes the steps of: a) designating a specific USB port in the personal computer; b) detecting whether the mobile device is connected to the specific USB port; c) checking whether the mobile device has been installed with a first driver; d) installing a first driver to the mobile device; e) sending a command to the mobile device to make it serve as a GOGGLE accessory device; f) installing a second driver in the personal computer for the mobile device as a GOGGLE accessory device; g) transferring a control right of an input device of the personal computer to the mobile device; h) converting signals of the input device into a format compatible with the mobile device; and i) sending the converted signals in step g) to the mobile device.

### BRIEF DESCRIPTION OF THE DRAWINGS

FIG. 1 is a schematic view showing a connection of a personal computer, input devices and mobile device; and

FIG. 2 is a flowchart of the method of the invention.

### DETAILED DESCRIPTION OF THE INVENTION

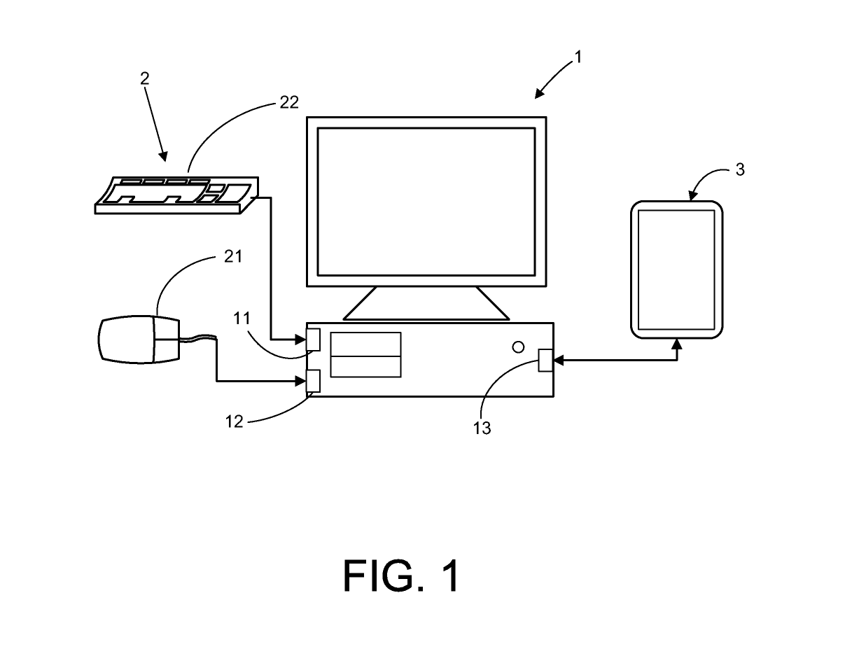

Please refer to FIG. 1. A personal computer 1, which may be a desktop computer or a laptop computer, is equipped with an input device 2 including a mouse 21 and a keyboard 22. The mouse 21 and keyboard 22 can be wiredly or wirelessly connected to the personal computer 1. A mobile device 3, such as a smartphone or a tablet computer, is connected to the personal computer 1 through a USB (universal serial bus) cable. When the invention is adopted, the keyboard 22 and mouse 21 can be directly used to operate the mobile device 3 without any manual operation. In other words, the control right of the input device 2 will be transferred from the personal computer 1 to the mobile device 3.

The method of the invention is performed by a software application installed in the personal computer 1. So far, the software application only applies to the mobile device 3 with the ANDROID operating system. However, it will be possible that the invention can be applied to mobile devices with operating systems other than ANDROID in the future.

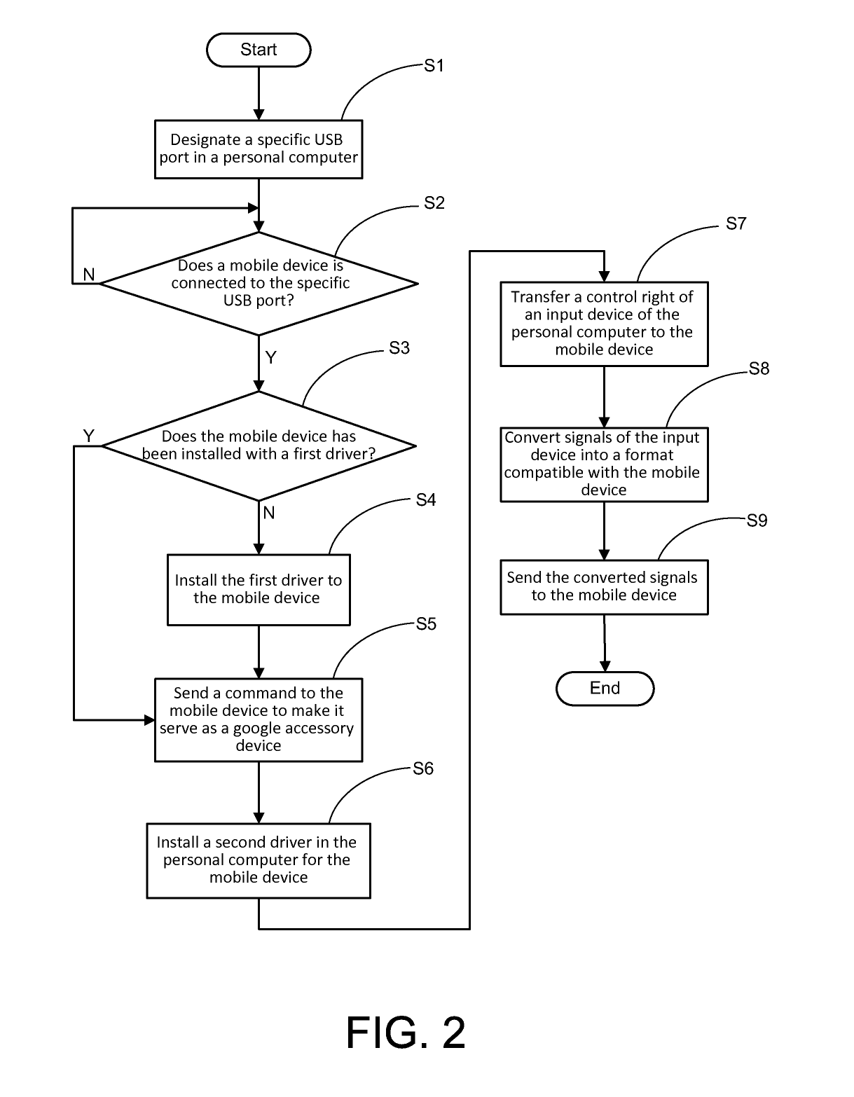

Please refer to FIG. 2, which shows a flowchart of the invention. First, in step S1, at least one of USB ports 11, 12, 13 of the personal computer 1 is designated to be a specific USB port 13. Alternately, the specific USB port 13 may also be a USB hub. Usually, there are several USB ports in a personal computer, only one or more are designated to be used for connecting a mobile device 3. Of course, the specific USB port 13 still keeps its originally general function and can be used to connect any other USB devices.

In step S2, the software application in the personal computer 1 detects whether a mobile device 3 is connected to the specific USB port 13 or not. If yes, in step S3, the software application checks whether the mobile device 3 has been installed with a first driver which matches the software application. The first driver can accept commands from the software application in the personal computer 1.

In step S4, the software application in the personal computer 1 installs a first driver to the mobile device 3 if the mobile device 3 has not been installed with the first driver. In detail, the step S4 will be executed only one time for each mobile device 3. When the mobile device 3 is not connected to the personal computer 1 at the very first time, the mobile device 3 should have been installed with the first driver and the step S4 will not need to be performed.

In step S5, the software application in the personal computer 1 sends a command to the mobile device 3 to make it serve as a GOOGLE accessory device. For ANDROID operating system, the command is an ADK (accessory development kit) command. The ADK command is used to erase the original PID (Product ID) and VID (Vendor ID) and to generate a new PID and VID as a GOOGLE accessary device. After that, the mobile device is identified as a GOOGLE accessary device.

In step S6, the software application in the personal computer 1 installs a second driver in the personal computer 1 for the mobile device 3 as a GOOGLE accessory device. Because the mobile device 3 has become a GOOGLE accessory device, the personal computer 1 must have a new driver (i.e., the second driver) to match the mobile device 3 as a GOOGLE accessory device.

In step S7, the software application in the personal computer 1 sends a command to transfer a control right of an input device 2 of the personal computer 1 to the mobile device 3.

In step S8, the software application in the personal computer 1 converts signals of the input device 2 into a format compatible with the mobile device 3. Because the personal computer 1 and the mobile device 3 separately use different operating systems, signals from the input device 2 connected to the personal computer 1 must be converted first so as to be used by the mobile device 3.

Finally, in step S9, the software application sends the converted signals to the mobile device 3. Thus the input device 2 can be used to operate the mobile device 3.

By the method of the invention, the input device 2 of the personal computer 1 can be automatically functionally transferred to the mobile device 3 without any manual operation. This is very useful and helpful for users.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for automatically functionally transferring an input device of a personal computer to a mobile device, the method comprising the steps of:
a) designating a specific USB (universal serial bus) port in the personal computer;
b) detecting whether the mobile device is connected to the specific USB port or not;
c) checking whether the mobile device has been installed with a first driver if yes instep b);
d) installing the first driver to the mobile device if no in step c);
e) sending a command to the mobile device to make it serve as a GOOGLE accessory device;
f) installing a second driver in the personal computer for the mobile device as a GOOGLE accessory device;
g) transferring a control right of an input device of the personal computer to the mobile device;
h) converting signals of the input device into a format compatible with the mobile device; and
i) sending the converted signals in step h) to the mobile device.

2. The method of claim 1, wherein the mobile device is ANDROID-based.

3. The method of claim 2, wherein the command in step e) is an accessory development kit (ADK) command.

4. The method of claim 1, wherein the specific USB port is a USB hub.

5. The method of claim 1, wherein the mobile device is a smartphone.

6. The method of claim 1, wherein the mobile device is a tablet computer.

7. The method of claim 1, wherein the input device comprises a mouse.

8. The method of claim 1, wherein the input device comprises a keyboard.
